(19) United States
(12) Patent Application Publication
(10) Pub. No.: US 2026/0358306 A1
(43) Pub. Date: Nov. 12, 2026

(54) INSPECTION METHOD FOR RESIDUE OF DEPOSITION DEVICE AND INSPECTION SYSTEM FOR RESIDUE

(71) Applicant: Samsung Display Co., Ltd., Yongin-si (KR)

(72) Inventors: Jeong Suk BAEK, Yongin-si (KR); Eui Hyun LEE, Yongin-si (KR)

(21) Appl. No.: 19/408,995

(22) Filed: Dec. 4, 2025

(30) Foreign Application Priority Data
May 7, 2025 (KR) 10-2025-0058914

(51) Int. Cl. G01N 30/72; B01D 15/42; G01N 30/14; G01N 30/54; G01N 30/02

(52) U.S. Cl. CPC G01N 30/7233; B01D 15/426; G01N 30/14; G01N 30/54; G01N 2030/027

(57) ABSTRACT

An inspection method for a residue of a deposition device and inspection system for the residue are provided. An inspection method for a residue of a deposition device includes: preparing an analysis sample by extracting the residue on a component of the deposition device with an eluate; preparing a mobile phase containing water, acetonitrile and tetrahydrofuran; and analyzing the analysis sample with a liquid chromatography-mass spectrometry (LC-MS) including the mobile phase. The mobile phase contains 10 parts by weight to 30 parts by weight of the water, 20 parts by weight to 60 parts by weight of the acetonitrile, and 20 parts by weight to 60 parts by weight of the tetrahydrofuran.

### CROSS-REFERENCE TO RELATED APPLICATION

The present application claims priority to and the benefit of Korean Patent Application No. 10-2025-0058914, filed on May 07, 2025, in the Korean Intellectual Property Office, the entire content of which is incorporated herein by reference.

### BACKGROUND

### 1. Field

The present disclosure relates to an inspection method for a residue of a deposition device and an inspection system for the residue.

### 2. Description of the Related Art

With the advancement of the information age, the demand for a display device for displaying an image in various forms has increased. The display device may be a flat panel display device such as a liquid crystal display device, a field emission display device and/or a light emitting display device. The light emitting display device may include an organic light emitting display device including an organic light emitting diode element as a light emitting element, or an inorganic light emitting diode display device including an inorganic light emitting diode element such as a light emitting diode (LED) as a light emitting element.

The display device may include a plurality of thin films formed on a substrate. Among the methods for forming thin films, there is a deposition method using a deposition device. Components of the deposition device may be contaminated during multiple depositions of various materials using the deposition device. Because the contaminants may adversely affect the performance of the display device, it may be necessary or desirable to clean the components of the deposition device. However, comparable cleaning verification methods may fail to detect trace amounts of contaminants that may still adversely impact device reliability. As such, there is a demand or desire for a method for checking the presence of the trace amounts of contaminants on the components of the cleaned deposition device.

### SUMMARY

Aspects of the present disclosure are directed toward a method for analyzing trace amount of materials (trace-level contaminants) remaining on components of a deposition device and an inspection system for the residue.

The aspects of the present disclosure are not limited to those mentioned above and additional aspects of the present disclosure, which are not mentioned herein, will be clearly understood by those skilled in the art from the following description of the present disclosure.

According to embodiments of the present disclosure, a method for inspecting a residue of a deposition device includes: preparing an analysis sample by extracting the residue on a component of the deposition device with an eluate; preparing a mobile phase containing water, acetonitrile and tetrahydrofuran; and analyzing the analysis sample with a liquid chromatography-mass spectrometry (LC-MS) with the mobile phase, wherein, the mobile phase contains about 10 parts by weight to about 30 parts by weight of the water, about 20 parts by weight to about 60 parts by weight of the acetonitrile, and about 20 parts by weight to about 60 parts by weight of the tetrahydrofuran, based on 100 parts by weight of the mobile phase.

The eluate may include tetrahydrofuran and methylene chloride.

The liquid chromatography-mass spectrometry may include a column, and analysis is performed at a column temperature of about 20°C to about 40°C.

Before preparing the analysis sample, the method may further include cleaning the component of the deposition device; and inspecting the residue by irradiating ultraviolet rays to the component of the deposition device.

The preparing of the analysis sample may be performed if (e.g., when) it is determined that the residue is not detected during the inspecting the residue.

A molecular weight of the residue analyzed with the liquid chromatography-mass spectrometry may be about 50 to about 2,000.

A mass to charge ratio (m/z) of a fragment ion of the residue analyzed with the liquid chromatography-mass spectrometry may be m/z 92.06, m/z 154.08, m/z 168.06, m/z 194.11, m/z 318.14, m/z 97.09, m/z 178.08, m/z 128.06, m/z 245.12 or m/z 81.03.

The method may further include adjusting a cleaning recipe of the component of the deposition device in accordance with the analysis result of the residue analyzed with the liquid chromatography-mass spectrometry.

The deposition device may be for manufacturing of a display device and/or an electronic device.

According to embodiments of the present disclosure, an inspection system for a residue includes: an accommodation unit for accommodating an inspection target; a supply unit for supplying an eluate to the accommodation unit; an extraction unit for recovering the eluate that is in contact with the inspection target; a pretreatment unit for treating the eluate with an analysis sample; and an analysis unit for analyzing the analysis sample, wherein the analysis unit performs analysis with a liquid chromatography-mass spectrometry (LC-MS), and the liquid chromatography-mass spectrometry includes a mobile phase, and the mobile phase contains about 10 parts by weight to about 30 parts by weight of the water, about 20 parts by weight to about 60 parts by weight of the acetonitrile, and about 20 parts by weight to about 60 parts by weight of the tetrahydrofuran, based on 100 parts by weight of the mobile phase.

The eluate may include tetrahydrofuran and methylene chloride.

The liquid chromatography-mass spectrometry may include a column, and analysis is performed at a column temperature of about 20°C to about 40°C.

The inspection system further includes: a control unit for analyzing data of the analysis unit; and a cleaning unit connected to the accommodation unit and the control unit to clean the inspection target accommodated in the accommodation unit.

The inspection system further includes a UV inspection unit connected to the accommodation unit and the control unit to inspect the residue by irradiating ultraviolet rays to the inspection target accommodated in the accommodation unit.

The control unit is configured to command the supply unit to supply the eluate to the accommodation unit in case that it is determined that the residue of the inspection target may be not detected by the UV inspection unit.

The control unit is configured to change a cleaning recipe of the cleaning unit in case that a value of the data may be out of a reference value.

A molecular weight of the residue of the inspection target analyzed with the liquid chromatography-mass spectrometry may be about 50 to about 2,000.

A mass to charge ratio (m/z) of a fragment ion of the residue analyzed with the liquid chromatography-mass spectrometry may be m/z 92.06, m/z 154.08, m/z 168.06, m/z 194.11, m/z 318.14, m/z 97.09, m/z 178.08, m/z 128.06, m/z 245.12 or m/z 81.03.

The inspection target may include a component of a deposition device used to manufacture a display device or an electronic device.

An inspection method for a residue of a deposition device according to the present disclosure relates to a method for inspecting trace amounts of residue remaining on components of a deposition device. Conditions such as a mobile phase used in chromatography, a temperature of a column, and a solvent used for elution may be adjusted so that the residue on the components of the deposition device may be accurately analyzed. In particular, the residue in which 15 or more types (kinds) of substances are mixed may be separated and analyzed in one (e.g., a single) analysis, so that time may be saved.

Trace amounts of residue may be detected and then cleaned, so that a contamination level of the components of the deposition device may be significantly reduced. If (e.g., when) deposition is performed with the components of the deposition device from which trace amounts of contaminants have been removed, reliability of a display device or an electronic device may be improved. For example, to further ensure the effectiveness of residue detection and cleaning, the inspection system may incorporate a control unit configured to receive analytical data from the LC-MS and dynamically adjust cleaning parameters such as solvent type, ultrasonic intensity, and rinse cycles. By integrating real-time feedback and adaptive cleaning protocols, the system enhances contamination control and supports consistent device performance.

The aspects/effects according to the embodiments of the present disclosure are not limited to those mentioned above and more one or more suitable aspects/effects are included in the following detailed description of the present disclosure.

### BRIEF DESCRIPTION OF THE DRAWINGS

The above and other aspects and features of the present disclosure will become more apparent by describing in more detail example embodiments thereof with reference to the attached drawings, in which:

FIG. 1 is a flow chart illustrating an inspection method for a residue of a deposition device according to one or more embodiments;

FIG. 2 is a block diagram illustrating an inspection system for a residue according to one or more embodiments;

FIG. 3 is an image taken when UV inspection is performed before cleaning components of a deposition device according to one or more embodiments;

FIG. 4 is an image taken when UV inspection is performed after cleaning components of a deposition device according to one or more embodiments;

FIG. 5 is a graph illustrating results of inspecting a residue of components of a deposition device for each cleaning company using a mobile phase manufactured in accordance with one or more embodiments; and

FIG. 6 is a graph illustrating results of inspecting a residue of components of a deposition device using various mobile phases.

### DETAILED DESCRIPTION

It should be understood that the enhancements and features of this disclosure, as well as the method of utilizing the described system, are described in more detail below along with the accompanying drawings. However, the present disclosure is not limited by the example embodiments, such as the particular types (kinds) of example resources. The present disclosure is intended to fully encompass the scope of the present disclosure and to provide a comprehensive understanding of the technology to those skilled in the art in one or more suitable technical fields. This scope of the present disclosure is defined by the appended claims and equivalents thereof.

The term "on" refers to elements or layers in different locations or layers, including one location or layer being directly overlapping or on the other location or layer, or intervening elements may also be present. Like reference numerals designate like elements throughout, and duplicative descriptions thereof may not be provided in the specification. For the purpose of explanation, example descriptions of shapes, shapes, shapes, and/or the like, are not intended to limit the described features.

The present disclosure is not limited to the existence of one or more suitable components, such as first and second bearings. For example, the terms “first,” “second,” etc., may be used herein to describe various components. However, these components should not be limited by these terms. These terms are only used to distinguish one component from another. For example, a first component could be termed a second component, and, similarly, a second component could be termed a first component, without departing from the scope of embodiments of the present disclosure. The one or more suitable features of the present disclosure may be partially or in part combined or combined with each other, and one or more suitable technical modifications and combinations are possible, and each example may interact with each other and be related to each other.

Hereinafter, example embodiments will be described in more detail with reference to the accompanying drawings.

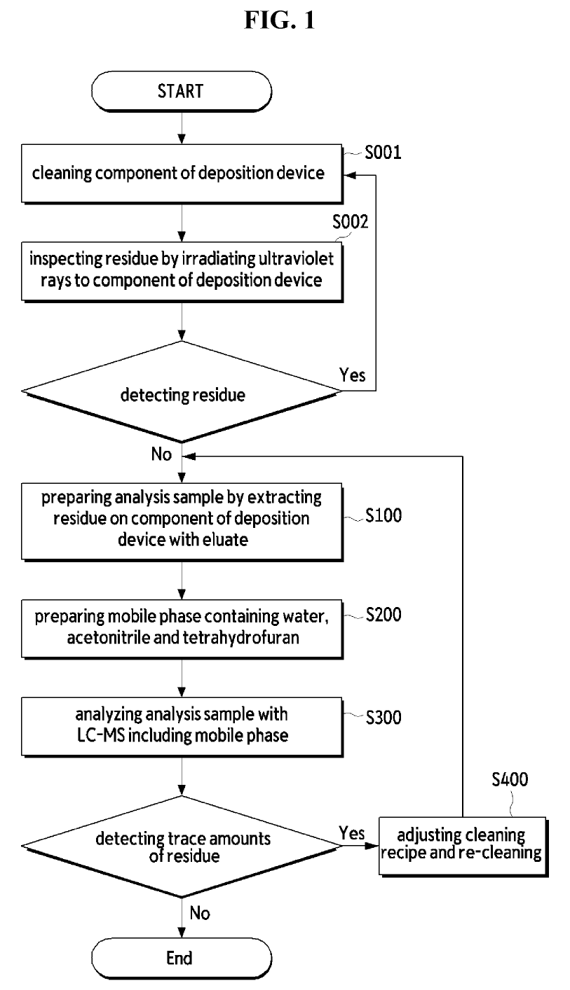

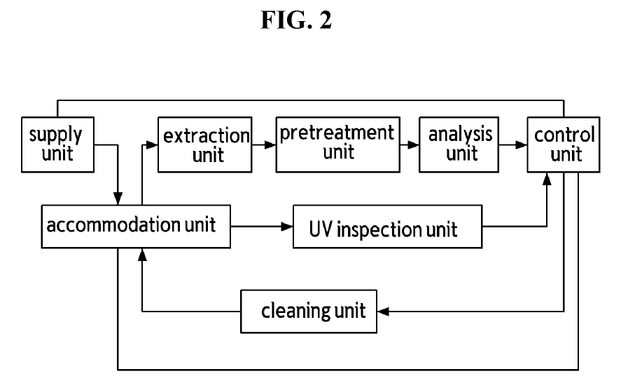

FIG. 1 is a flow chart illustrating an inspection method for a residue of a deposition device according to one or more embodiments. FIG. 2 is a block diagram illustrating an inspection system for a residue according to one or more embodiments.

Referring to FIG. 2, the inspection system for a residue may include an accommodation unit, a supply unit, an extraction unit, a pretreatment unit, an analysis unit, a control unit, a cleaning unit, and a UV inspection unit.

Referring to FIG. 1, first, components of the deposition device may be cleaned (S001). The deposition device may be used if (e.g., when) a display device or an electronic device is manufactured. The deposition device may include an evaporator. The evaporator may evaporate an organic material to deposit the organic material on a substrate.

The components of the deposition device may be accommodated in the accommodation unit. A solvent of the cleaning unit may be injected into the accommodation unit to immerse the components of the deposition device. Contaminants on the components of the deposition device may be removed by the solvent. In order to (e.g., effectively) remove the contaminants, ultrasonic waves may be applied to the components of the deposition device and the accommodation unit in which the solvent is accommodated. The solvent, by which contaminants are extracted, may be removed from the accommodation unit. Then the (e.g., same) solvent, from which the contaminants have been removed, may be injected again into the accommodation unit (from which the previously injected solvent has been removed), so that the components of the deposition device may be immersed again in the solvent. The components of the deposition device may be repeatedly immersed and the solvent may be repeatedly removed, so that the contaminants on the components of the deposition device may be (e.g., effectively) removed.

If (e.g., when) it is determined that the contaminants on the components of the deposition device have been sufficiently removed as the components of the deposition device have been repeatedly immersed and the solvent has been repeatedly removed, the residue may be inspected by irradiating ultraviolet rays to the components of the deposition device (S002). The inspection of the residue may be performed by the UV inspection unit.

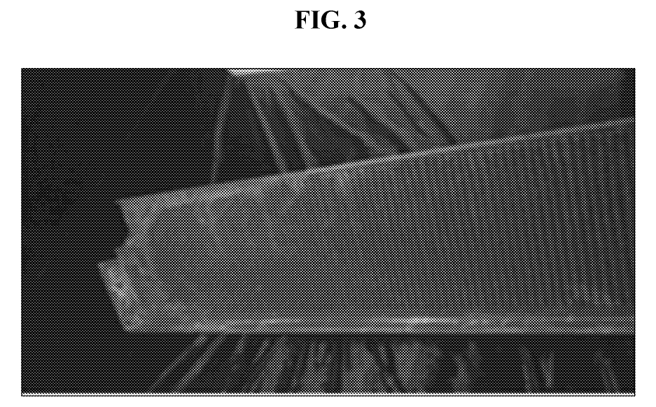

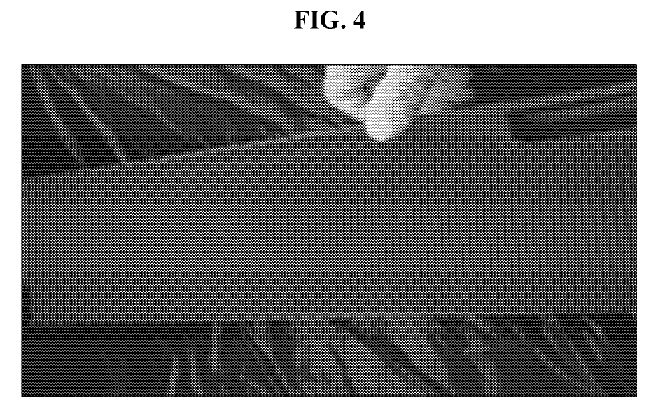

FIG. 3 is an image taken when UV inspection is performed before cleaning components of a deposition device according to one or more embodiments. FIG. 4 is an image taken when UV inspection is performed after cleaning components of a deposition device according to one or more embodiments.

Referring to FIG. 3, if (e.g., when) ultraviolet rays are irradiated to the components of the deposition device before cleaning the deposition device, it may be noted that a residue remains even if (e.g., when) viewed with the naked eye. Referring to FIG. 4, if (e.g., when) the ultraviolet rays are irradiated to the components of the deposition device after cleaning the deposition device with a solvent several times, it may be noted that no residue remains if (e.g., when) viewed with the naked eye.

In the related art, if (e.g., when) inspection is performed by irradiating ultraviolet rays to the components of the cleaned deposition device, it is determined that cleaning is completed if (e.g., when) no residue is visible with the naked eye as shown in FIG. 4. However, if (e.g., when) there are contaminants remaining as a highly integrated display device or electronic device is manufactured, they may affect performance of the display device or the electronic device. Even when it is determined that cleaning is completed by visual inspection by irradiating ultraviolet rays to the components of the deposition device, trace amounts of residue may still remain on the components of the deposition device. Currently, there is no method of analyzing trace amounts of contaminants remaining in the components of the deposition device.

The present disclosure relates to an inspection method of trace amounts of residue on components of a deposition device. Conditions such as a mobile phase used in chromatography, a temperature of a column, and a solvent used for elution may be adjusted so that the residue on the components of the deposition device may be accurately analyzed. For example, the residue in which 15 or more types (kinds) of substances are mixed may be separated and analyzed in one (e.g., a single) analysis, so that time may be saved.

If (e.g., when) it is determined that no residue is detected in the step (e.g., act or task) of performing visual inspection by irradiating ultraviolet rays onto the components of the deposition device, the step (e.g., act or task) of preparing an analysis sample may be performed.

The analysis sample may be prepared by extracting the residue on the components of the deposition device with an eluate (S100). The eluate may be injected into the accommodation unit in which the components of the deposition device are accommodated. The supply unit includes the eluate, and may supply the eluate to the accommodation unit as much as desired or required. The components of the deposition device are in contact with the eluate, so that the residue adsorbed on the components of the deposition device may be eluted. The eluate in which the residue is eluted from the components of the deposition device may be recovered from the extraction unit. The pretreatment unit may pretreat the eluate, in which the residue is eluted, to be suitable for analysis conditions. The pretreatment may include performing adjustment of the concentration and/or pH of the recovered eluate. For example, a solvent may be added to lower the concentration of the eluate in which the residue is eluted.

The eluate may include tetrahydrofuran and methylene chloride. Tetrahydrofuran may allow the residue to be easily eluted from the components of the deposition device. Methylene chloride may reduce damage to the components of the deposition device. Tetrahydrofuran and methylene chloride may be injected into the accommodation unit concurrently (e.g., simultaneously or as a mixture) or respectively (e.g., individually).

Subsequently, a mobile phase containing water, acetonitrile and tetrahydrofuran may be prepared (S200). In 100 parts by weight of the mobile phase, the mobile phase may contain about 10 parts by weight to about 30 parts by weight of water, about 20 parts by weight to about 60 parts by weight of acetonitrile, and about 20 parts by weight to about 60 parts by weight of tetrahydrofuran. If (e.g., when) the mobile phase does not contain all of water, acetonitrile, and tetrahydrofuran, the analysis result may not be accurate. If (e.g., when) the mobile phase contains all three components but their proportions are out of the content (e.g., amount) range of about 10 parts by weight to about 30 parts by weight of water, about 20 parts by weight to about 60 parts by weight of acetonitrile, and about 20 parts by weight to about 60 parts by weight of tetrahydrofuran, the analysis result may not be accurate. For example, if (e.g., when) acetonitrile is lower than about 20 parts by weight, a retention time may be delayed, peaks may overlap, and the number of detected peaks may be reduced. If (e.g., when) tetrahydrofuran is lower than about 20 parts by weight, peaks may overlap and the number of detected peaks may be reduced.

Subsequently, the analysis sample may be analyzed by the analysis unit. The analysis unit may perform analysis with a liquid chromatography-mass spectrometry (LC-MS). In more detail, the analysis sample may be analyzed using a liquid chromatography-mass spectrometry (LC-MS) with the mobile phase (S300).

The liquid chromatography-mass spectrometry may include a column. The column may be selected from reversed-phase columns, such as C18 (octadecylsilane) and/or phenyl-hexyl columns, depending on the polarity of the residue compounds. Analysis of the liquid chromatography-mass spectrometry may be performed at a column temperature of about 20°C to about 40°C. If (e.g., when) the column temperature is lower than about 20°C, the retention time increases, and thus the analysis time may increase. If (e.g., when) the column temperature is higher than about 40°C, the peaks may overlap, thereby making it difficult to analyze each material.

A molecular weight of the residue analyzed with the liquid chromatography-mass spectrometry may be about 50 to about 2,000. A fragment ion of the residue analyzed with the liquid chromatography-mass spectrometry may have (e.g., may be) mass-to-charge ratio (m/z) 92.06, m/z 154.08, m/z 168.06, m/z 194.11, m/z 318.14, m/z 97.09, m/z 178.08, m/z 128.06, m/z 245.12 or m/z 81.03.

Qualitative analysis may be performed based on mass-to-charge ratio (m/z) information of a mass spectrometry. For example, if (e.g., when) m/z is 92.0626, the substance may be determined as toluene with a molecular formula C₇H₈. If (e.g., when) m/z is 154.0783, the substance may be determined as biphenyl with a molecular formula C₁₂H₁₀. If (e.g., when) m/z is 168.0575, the substance may be determined as dibenzofuran with a molecular formula C₁₂H₈O. If (e.g., when) m/z is 194.1096, the substance may be determined as 9,9-dimethyl-9H-fluorene with a molecular formula C₁₅H₁₄. If (e.g., when) m/z is 318.1409, the substance may be determined as 9,9-diphenyl-9H-fluorene with a molecular formula C₂₅H₁₈. If (e.g., when) m/z is 97.0940, the substance may be determined as toluene-2,3,4,5,6-d₅ with the molecular formula C₇H₃D₅. If (e.g., when) m/z is 178.0783, the substance may be determined as anthracene with a molecular formula C₁₄H₁₀. If (e.g., when) m/z is 128.0626, the substance may be determined as naphthalene with the molecular formula C₁₀H₈. If (e.g., when) m/z is 245.1204, the substance may be determined as trimethylamine with a molecular formula C₁₈H₁₅N. If (e.g., when) m/z is 81.0327, the substance may be determined as 1,3,5-triazine with a molecular formula C₃H₃N₃.

The mass-to-charge ratio (m/z) information analyzed with the liquid chromatography-mass spectrometry may be displayed with 4 decimal places (e.g., accurate to the 4^{th} decimal place), thereby improving accuracy of the analyzed material (e.g., accuracy of material identification).

Quantitative analysis of the residue may be performed by analyzing peaks generated by liquid chromatography.

The results of quantitative and qualitative analysis of the analysis unit may be forwarded to the control unit. The control unit may analyze data of the analysis unit. The cleaning unit may be connected to the accommodation unit and the control unit. The control unit may adjust a cleaning recipe in accordance with the analysis result of the residue. The cleaning recipe may include parameters such as solvent type, ultrasonic intensity, immersion duration, and/or rinse cycles, which may be dynamically modified based on the detected residue profile. If (e.g., when) the cleaning recipe changed by the control unit is forwarded to the cleaning unit, the cleaning unit may clean an inspection target (the components of the deposition device) accommodated in the accommodation unit in accordance with the changed cleaning recipe.

If (e.g., when) a data value of the analysis unit is out of a reference value (e.g., range), the control unit may change the cleaning recipe of the cleaning unit. If (e.g., when) the amount of the residue is greater than a certain or set level in the analysis result, the number of cleaning times may be increased. If (e.g., when) an ingredient that may affect performance of the display device or the electronic device is detected from the residue, re-cleaning may be performed using a solvent having higher solubility for the corresponding ingredient. In one or more embodiments, as show in FIG. 2, the control unit interfaces with the cleaning unit to execute modified cleaning protocols based on analytical feedback.

According to embodiments of the present disclosure, trace amounts of residue may be detected, and the detected residue may be cleaned, so that the contamination of the components of the deposition device may be significantly reduced. If (e.g., when) deposition is performed with the components of the deposition device from which trace amounts of contaminants is removed, reliability of the display device or the electronic device may be improved.

The present disclosure will be described in more detail through the following examples, but the following examples are intended for the purpose of description only and are not intended to limit the scope of the present disclosure.

### 1. Preparation of mobile phase

### 1. Preparation Example 1

A mobile phase was prepared by mixing 15 wt% of water, 40 wt% of acetonitrile, and 45 wt% of tetrahydrofuran.

### 2. Comparative Preparation Example 1

A mobile phase was prepared by mixing 30 wt% of water, 56 wt% of acetonitrile, and 14 wt% of tetrahydrofuran.

### 3. Comparative Preparation Example 2

A mobile phase was prepared by mixing 30 wt% of water, 14 wt% of acetonitrile, and 56 wt% of tetrahydrofuran.

### 2. Checking residue of components of deposition device for each cleaning company

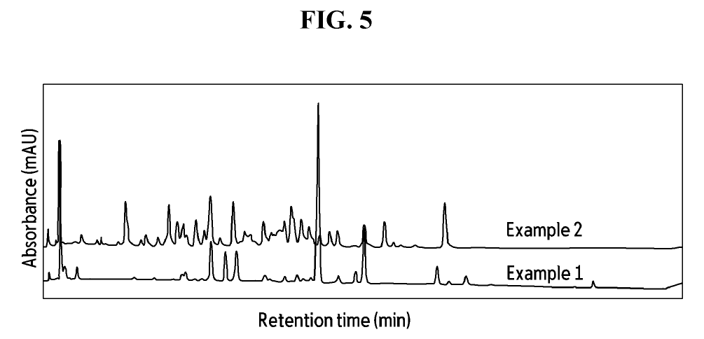

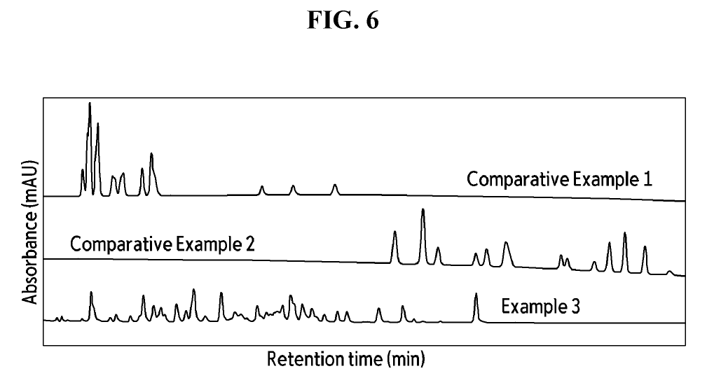

After the cleaning of the components of the deposition device was completed by (e.g., entrusted to) another company, the components of the deposition device that were determined to have been completely cleaned (passed an ultraviolet visual inspection) were inspected for a residue, and the results are shown in FIGS. 5 and 6.

FIG. 5 is a graph illustrating results of inspecting residue of components of a deposition device for each cleaning company using a mobile phase manufactured in accordance with one or more embodiments.

In more detail, Example 1 of FIG. 5 is an inspection result for a residue of the deposition device that was cleaned by Company A, which is measured by LC-MS with the mobile phase of the Preparation Example 1, and Example 2 is an inspection result for a residue of the deposition device that was cleaned by Company B, which is measured by LC-MS with the mobile phase of the Preparation Example 1.

According to the results shown in FIG. 5, it may be noted that a residue is detected from the components of the deposition device, which had been determined by Company A and Company B that cleaning has been completed. It may be determined that trace amounts of residue, which is not detected by UV visual inspection, remains on the components of the deposition device.

FIG. 6 is a graph illustrating results of inspecting residue of components of a deposition device using different mobile phases.

In more detail, FIG. 6 illustrates that the components of the deposition device, which had been determined by Company C that cleaning has been completed, are measured by LC-MS. Comparative Example 1 is measured using the mobile phase of the Comparative Preparation Example 1, Comparative Example 2 is measured using the mobile phase of the Comparative Preparation Example 2, and Example 3 is measured using the mobile phase of the Preparation Example 1.

According to the results shown in FIG. 6, in case of the Comparative Example 1 in which tetrahydrofuran is less than a reference content (e.g., amount) value, analysis of each ingredient of the residue may be difficult due to a lot of overlap between peaks. Also, because the number of detected peaks is reduced, it may be difficult to identify ingredients of the residue. In case of the Comparative Example 2 in which acetonitrile is less than a reference content (e.g., amount) value, a retention time of detection may be delayed and thus an inspection time may be longer. Also, it may be difficult to identify ingredients of the residue because the overlap between the peaks and the number of detected peaks are reduced. In case of the Example 3, it may be noted that a large number of peaks are detected in a separated state during the analysis time. As a plurality of separated peaks are detected, the ingredients of the residue may be more accurately identified.

As shown in FIG. 6, the residue of the components of the deposition device may be accurately inspected if (e.g., when) the content (e.g., amount, composition) of the mobile phase of LC-MS is according to embodiments of the present disclosure.

In one or more embodiments, the control unit may receive LC-MS data and modify cleaning parameters, accordingly, ensuring that the residue is effectively removed.

It will be understood that the terms "includes," "including," “comprises,” and/or “comprising,” when used in this specification, specify the presence of stated features, steps, operations, elements, and/or components, but do not preclude the presence or addition of one or more other features, steps, operations, elements, components, and/or groups thereof. As used herein, the term "combination thereof" refers to a mixture, a laminate, a composite, a copolymer, an alloy, a blend, a reaction product, and/or the like of the constituents. Additionally, the terms “comprise(s)/comprising,” “include(s)/including,” “have/has/having”, or other similar terms include or support the terms “consisting of” and “consisting essentially of,” indicating the presence of stated features, integers, steps, operations, elements, and/or components, without or essentially without the presence of other features, integers, steps, operations, elements, components, and/or groups thereof.

As used herein, the terms "use," "using," and "used" may be considered synonymous with the terms "utilize," "utilizing," and "utilized," respectively.

The use of “may” when describing embodiments of the inventive concept refers to “one or more embodiments of the inventive concept.”

As utilized herein, the terms “substantially,” “about,” or similar terms are used as terms of approximation and not as terms of degree, and are intended to account for the inherent deviations in measured or calculated values that would be recognized by those of ordinary skill in the art. “About” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ± 30%, 20%, 10%, or 5% of the stated value. Also, it should be understood that, even if the terms “about,” “approximately,” or “substantially” are not expressly recited in a given element *e.g., a claim element), the scope of such element is intended to include variations that are insubstantial or within the understanding of one of ordinary skill in the art. For example, numerical values and ranges provided herein are intended to include tolerances and measurement uncertainties that would be recognized by those skilled in the art, and the elements (e.g., claim elements) should be construed accordingly to encompass such equivalents.

Also, any numerical range recited herein is intended to include all sub-ranges of the same numerical precision subsumed within the recited range. For example, a range of "1.0 to 10.0" is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

The display apparatus/device, the electronic apparatus/device, the deposition device, the inspection system, the manufacturing apparatuses thereof, or any other relevant apparatuses/devices or components according to embodiments of the present disclosure described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

Hereinbefore, the certain embodiments of the present disclosure have been described and illustrated, however, it is apparent to a person with ordinary skill in the art that the present disclosure is not limited to these embodiments as described, and may be variously modified and transformed without departing from the spirit and scope of the present disclosure. Descriptions of features or aspects within each embodiment should typically be considered as available for other similar features or aspects in other embodiments. Accordingly, it is to be understood that present disclosure is not limited to the disclosed embodiments, but, on the contrary, is intended to cover various modifications and equivalent arrangements included within the spirit and scope of the appended claims, and equivalents thereof.

Although embodiments of the present disclosure have been described with reference to the attached drawings, those skilled in the art will appreciate that the present disclosure can be implemented in other specific forms without altering the technical spirit or essential characteristics of the present disclosure. Therefore, the embodiments described above should be understood to be illustrative in all respects and not restrictive.

What is claimed is:

1. A method comprising:
preparing an analysis sample by extracting the residue on a component of the deposition device with an eluate;
preparing a mobile phase comprising water, acetonitrile and tetrahydrofuran; and
analyzing the analysis sample with a liquid chromatography-mass spectrometry (LC-MS) with the mobile phase,
wherein, the mobile phase comprises 10 parts by weight to 30 parts by weight of the water, 20 parts by weight to 60 parts by weight of the acetonitrile, and 20 parts by weight to 60 parts by weight of the tetrahydrofuran, based on 100 parts by weight of the mobile phase, and
wherein the method is an inspection method for a residue of a deposition device.

2. The method of claim 1, wherein the eluate comprises tetrahydrofuran and methylene chloride.

3. The method of claim 1, wherein the liquid chromatography-mass spectrometry comprises a column, and analysis is performed at a column temperature of 20°C to 40°C.

4. The method of claim 1, further comprising, before the preparing of the analysis sample:
cleaning the component of the deposition device; and
inspecting the residue by irradiating ultraviolet rays to the component of the deposition device.

5. The method of claim 4, wherein the preparing of the analysis sample is performed if it is determined that the residue is not detected during the inspecting of the residue.

6. The method of claim 1, wherein a molecular weight of the residue analyzed with the liquid chromatography-mass spectrometry is 50 to 2,000.

7. The method of claim 6, wherein a mass to charge ratio (m/z) of a fragment ion of the residue analyzed with the liquid chromatography-mass spectrometry is m/z 92.06, m/z 154.08, m/z 168.06, m/z 194.11, m/z 318.14, m/z 97.09, m/z 178.08, m/z 128.06, m/z 245.12 or m/z 81.03.

8. The method of claim 6, further comprising adjusting a cleaning recipe of the component of the deposition device in accordance with an analysis result of the residue analyzed with the liquid chromatography-mass spectrometry.

9. The method of claim 1, wherein the deposition device is for manufacturing of a display device and/or an electronic device.

10. An inspection system for a residue, the inspection system comprising:
an accommodation unit to accommodate an inspection target;
a supply unit to supply an eluate to the accommodation unit;
an extraction unit to recover the eluate that is in contact with the inspection target;
a pretreatment unit to treat the eluate with an analysis sample; and
an analysis unit to analyze the analysis sample,
wherein the analysis unit is configured to perform analysis with a liquid chromatography-mass spectrometry (LC-MS),
the liquid chromatography-mass spectrometry comprises a mobile phase, and
the mobile phase comprises 10 parts by weight to 30 parts by weight of water, 20 parts by weight to 60 parts by weight of acetonitrile, and 20 parts by weight to 60 parts by weight of tetrahydrofuran, based on 100 parts by weight of the mobile phase.

11. The inspection system of claim 10, wherein the eluate comprises tetrahydrofuran and methylene chloride.

12. The inspection system of claim 10, wherein the liquid chromatography-mass spectrometry comprises a column, and analysis is performed at a column temperature of 20°C to 40°C.

13. The inspection system of claim 10, further comprising:
a control unit to analyze data of the analysis unit; and
a cleaning unit connected to the accommodation unit and the control unit to clean the inspection target accommodated in the accommodation unit.

14. The inspection system of claim 13, further comprising a UV inspection unit connected to the accommodation unit and the control unit to inspect the residue by irradiating ultraviolet rays to the inspection target accommodated in the accommodation unit.

15. The inspection system of claim 14, wherein the control unit is configured to command the supply unit to supply the eluate to the accommodation unit in case that it is determined that the residue of the inspection target is not detected by the UV inspection unit.

16. The inspection system of claim 13, wherein the control unit is configured to change a cleaning recipe of the cleaning unit in case that a value of the data is out of a reference range.

17. The inspection system of claim 10, wherein a molecular weight of the residue of the inspection target analyzed with the liquid chromatography-mass spectrometry is 50 to 2,000.

18. The inspection system of claim 17, wherein a mass to charge ratio (m/z) of a fragment ion of the residue analyzed with the liquid chromatography-mass spectrometry is m/z 92.06, m/z 154.08, m/z 168.06, m/z 194.11, m/z 318.14, m/z 97.09, m/z 178.08, m/z 128.06, m/z 245.12 or m/z 81.03.

19. The inspection system of claim 10, wherein the inspection target comprises a component of a deposition device utilized to manufacture a display device or an electronic device.

20. A system comprising:
means for preparing an analysis sample by extracting the residue on a component of the deposition device with an eluate;
means for preparing a mobile phase comprising water, acetonitrile and tetrahydrofuran; and
means for analyzing the analysis sample with a liquid chromatography-mass spectrometry (LC-MS) with the mobile phase,
wherein, the mobile phase comprises 10 parts by weight to 30 parts by weight of the water, 20 parts by weight to 60 parts by weight of the acetonitrile, and 20 parts by weight to 60 parts by weight of the tetrahydrofuran, based on 100 parts by weight of the mobile phase, and
wherein the system is an inspection system for a residue of a deposition device.
